(19) United States
(12) Patent Application Publication
(10) Pub. No.: US 2026/0299544 A1
(43) Pub. Date: Oct. 1, 2026

(54) CALCULATION DEVICE

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 19/480,794

(22) PCT Filed: May 11, 2023
(86) PCT No.: PCT/JP2023/017812

§ 371 Date: Oct. 31, 2025

(51) Int. Cl. G05B 19/18

(52) U.S. Cl. CPC G05B 19/182; G05B 2219/45044

(57) ABSTRACT

The present invention provides technology with which it is possible to easily grasp whether or not a numerical value of a machining condition satisfies an assumed operation condition in a machine tool for performing rocking machining. A machine tool calculation device 1 comprises: a machining condition acquisition unit 11 that acquires, as a first machining condition, at least one of a spindle rotation speed, a feed speed, a frequency parameter, and an amplitude parameter included in the machining conditions; a determination unit 13 that acquires, as determination criteria, a first criterion that is set for a rocking operation based on the first machining condition and at least one second machining condition not acquired as the first machining condition among the machining conditions, and a second criterion that is set for a rocking operation determined only by the second machining condition; and an output unit 14 that outputs the determination result of the determination unit 13. When the numerical value of the first machining condition is applied, the determination unit 13 determines whether or not a numerical value of the second machining condition satisfying the first criterion and the second criterion exists.

### TECHNICAL FIELD

The present disclosure relates to a calculation device.

### BACKGROUND ART

There are known technologies for causing a machine tool to execute oscillation machining by oscillating a tool relative to a workpiece so that chips are shredded (see, for example, Patent Document 1 and Patent Document 2).

### CITATION LIST

### Patent Document

Patent Document 1: Japanese Patent No. 6843313
Patent Document 2: PCT International Publication No. WO2021/167014

### DISCLOSURE OF THE INVENTION

### Problems to be Solved by the Invention

Machining conditions for the oscillation cutting include a spindle rotation number, a feed speed, a frequency multiplying factor that is the number of oscillations per rotation of a spindle, an amplitude ratio oscillation amplitude multiplying factor for the feed amount per rotation of the spindle, and the like. The machining conditions have to satisfy operability, such as maintaining an oscillating operation below an oscillation acceleration upper limit value and allowing for shredding chips.

However, when the spindle rotation number and the feed speed have excessively high setting values, there exist no setting values for the frequency multiplying factor and the amplitude multiplying factor that concurrently satisfy both the condition for preventing the oscillation acceleration upper limit value from being exceeded and the condition for allowing for shredding chips in some cases. In this case, the spindle rotation number and the feed speed need to be adjusted, but it is highly troublesome for an operator of the machine tool to grasp this situation. Aside from preventing the oscillation acceleration upper limit value from being exceeded and allowing for shredding chips, it is similarly difficult to grasp the situation under set machining conditions that satisfy two certain aspects.

The present disclosure has been achieved in view of the disadvantage described above, and an object of the present disclosure is to provide a technology adapted for a machine tool that performs oscillation machining and making it possible to easily grasp whether or not numerical values of machining conditions satisfy expected operation conditions.

### Means for Solving the Problems

The present disclosure provides a calculation device for a machine tool that performs oscillation machining while relatively oscillating a cutting tool and a workpiece. The calculation device includes: a machining condition acquisition unit; a determination unit; and an output unit. The machining condition acquisition unit is configured to acquire, as a first machining condition, at least one selected from a spindle rotation number, a feed speed, a frequency parameter, or an amplitude parameter included in machining conditions. The determination unit is configured to acquire a first criterion and a second criterion as determination criteria. The first criterion is set for an oscillating operation that is based on the first machining condition and at least one second machining condition that is not acquired from the machining conditions as the first machining condition. The second criterion is set for an oscillating operation that is defined by only the second machining condition. The output unit is configured to output a determination result of the determination unit. In a case where a numerical value of the first machining condition is applied, the determination unit determines whether or not a numerical value of the second machining condition that satisfies the first criterion and the second criterion exists.

### BRIEF DESCRIPTION OF THE DRAWINGS

FIG. 1 is a functional block diagram of a calculation device for a machine tool according to a first embodiment;

FIG. 2 is a flowchart showing an example of a flow of a calculation control process by the calculation device according to the first embodiment;

FIG. 3 is a diagram showing an example of an image displayed on a display unit by the calculation device;

FIG. 4 is a functional block diagram of a calculation device for a machine tool according to a fifth embodiment; and

FIG. 5 is a functional block diagram of a calculation device for a machine tool according to a sixth embodiment.

### PREFERRED MODE FOR CARRYING OUT THE INVENTION

Hereinafter, embodiments of the present disclosure will be described in detail with reference to the drawings. It is to be noted that components common to those of a first embodiment will be denoted by the same reference signs and the description thereof will be omitted as appropriate in the description of a second embodiment and the subsequent embodiments.

### First Embodiment

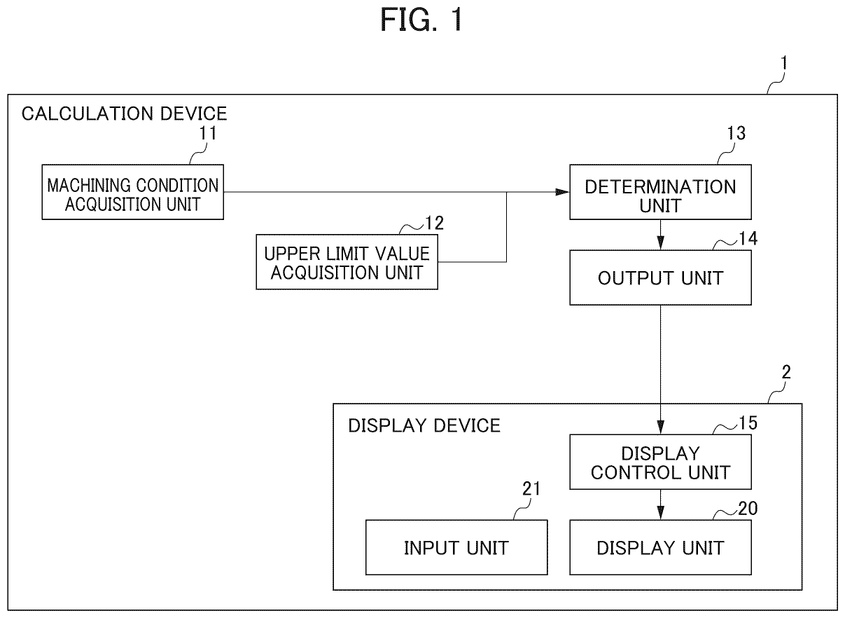

FIG. 1 is a functional block diagram of a calculation device 1 for a machine tool according to the first embodiment. The calculation device 1 according to the first embodiment is a computer that calculates various kinds of information about the machine tool which performs oscillation machining while relatively oscillating a cutting tool and a workpiece. The calculation device 1 assists in setting machining conditions for oscillation cutting. The calculation device 1 is connected to a control device for use. The control device is not shown and is, for example, a computer that controls the machine tool.

The machine tool operates at least one spindle that relatively rotates the cutting tool and the workpiece and at least one feed axis that relatively moves the cutting tool relative to the workpiece, thereby machining the workpiece using the cutting tool. The machine tool executes various kinds of machining on the basis of a machining program.

It is to be noted that the shape of the workpiece is not limited in machining by the machine tool according to the present embodiment. That is, the machine tool according to the present embodiment is applicable in any of cases where a plurality of feed axes (a Z axis and an X axis) is necessary because the workpiece has a tapered section or an arc-shaped section on a working surface and one specific feed axis (Z axis) suffices because the workpiece has a columnar shape or a cylindrical shape.

The hardware configuration of the calculation device 1 for the machine tool will be described. The calculation device 1 is configured using a computer including, for example, memories such as a ROM (read only memory) and a RAM (random access memory), a CPU (central processing unit), and a communication control unit that are connected to each other through a bus.

In addition, the calculation device 1 according to the present embodiment includes a display device 2 that displays various kinds of information. The display device 2 includes a display unit 20 and an input unit 21. The display unit 20 includes, for example, a display that displays various kinds of information. The input unit 21 is, for example, an operation means such as a touch panel, a keyboard, or a button for an operator to input various information.

The calculation device 1 for the machine tool may also be configured as a CNC (Computer Numerical Controller) and connected to a superordinate computer (not shown) such as a CNC or a PLC (Programmable Logic Controller). In addition to the machining program, a machining condition or the like such as rotation speed may be input to the calculation device 1 for the machine tool from the superordinate computer. Alternatively, the calculation device 1 may be an external computer that is not connected to the machine tool and is used to simulate oscillation cutting.

Next, functional units implemented in the calculation device 1 will be described. The calculation device 1 includes a machining condition acquisition unit 11, an upper limit value acquisition unit 12, a determination unit 13, and an output unit 14 as functional units. These functional units of the calculation device 1 are implemented by the cooperation of the CPU described above, a memory, and a control program stored in the memory.

The machining condition acquisition unit 11 is a machining condition acquisition function of acquiring machining conditions for performing oscillation machining. The machining conditions will be described. The machining conditions include information necessary for machining such as a spindle rotation number S (1/min), a feed amount F (mm/rev) per rotation of the spindle, the command position of the feed axis, and oscillation conditions. It is also possible to calculate the feed amount (mm/rev) per rotation of the spindle by combining the spindle rotation number (1/min) and the feed speed (mm/min) of the cutting tool.

The oscillation conditions included in the machining conditions will be described. The oscillation conditions include at least a frequency parameter that is information related to the oscillation frequency of the cutting tool or the workpiece and an amplitude parameter that is information related to the oscillation amplitude of the cutting tool or the workpiece as information for uniquely identifying a vibration waveform. The frequency parameter may be the number of vibrations per relative rotation of the cutting tool and the workpiece or the number of vibrations per unit time. Alternatively, the frequency parameter may be a periodic parameter of an advancing and retracting operation. The amplitude parameter may be information related to the oscillation amplitude for the feed amount per relative rotation of the cutting tool and the workpiece or be a distance parameter of the advancing and retracting operation. The periodic parameter of the advancing and retracting operation and the distance parameter of the advancing and retracting operation may be determined from the advancing speed, the retracting speed, the advancing distance, the retracting distance, the spindle rotation number, the control period, and the like. The frequency parameter and the amplitude parameter may be defined from the spindle rotation number, the feed speed every rotation, the feed speed every minute, a frequency multiplying factor that is the number of vibrations per relative rotation of the cutting tool and the workpiece, an amplitude multiplying factor that is the oscillation amplitude for the feed amount per relative rotation of the cutting tool and the workpiece, and the like.

In the present embodiment, oscillation frequency f (Hz) per rotation of the spindle or an oscillation frequency multiplying factor I (times) is used as the frequency parameter. The oscillation frequency multiplying factor I (times) may be directly designated, or the oscillation frequency (Hz) may be designated and the oscillation frequency multiplying factor I (multiplier) may be then calculated from the oscillation frequency (Hz) and the spindle rotation number S (1/min).

In addition, oscillation amplitude A (mm) for the magnitude of the feed amount per rotation of the spindle or an oscillation amplitude multiplying factor K (times) indicating the magnitude of the oscillation amplitude is used as the amplitude parameter. In addition, the oscillation amplitude multiplying factor K (times) may also be directly designated similarly.

Additionally, it is also possible to use the feed amount every minute as a machining condition. In addition, it is also possible to use the advancing amount, the advancing speed, the retracting amount, the retracting speed, the control period, the number of blades, and the like as machining conditions instead of the feed speed, the frequency parameter, and the amplitude parameter.

In addition, the machining condition acquisition unit 11 selects a first machining condition and a second machining condition from the machining conditions. For example, the first machining condition is a machining condition the numerical value of which has already been set. Alternatively, any machining condition selected by an operator from machining conditions the numerical values of which have already been set may be used as a first machining condition or which is a first machining condition may be defined on the basis of a rule defined in advance in the calculation device. The numerical value of a first machining condition may be designated in the calculation device 1, for example, by an operator through the input unit 21, an external computer, or the like in accordance with the display on the display unit 20 of the calculation device 1 or may be designated in advance in the machining program, a setting parameter of the machine tool, or the like. Meanwhile, the second machining condition is a machining condition that has not yet been determined. The second machining condition is a machining condition the numerical value of which needs to be determined. It is to be noted that the first machining condition and the second machining condition may each include one condition or a plurality of conditions. In addition, the numerical values of the second machining conditions may already be determined. However, even if the values have been input, the input values are ignored and the present technology is applied on the basis of a combination of the setting values of the second machining conditions which satisfy a second criterion again.

The upper limit value acquisition unit 12 is an upper limit value acquisition function of acquiring the upper limit value of an oscillation status (parameter).

The upper limit value of the oscillation status is set as L_{A} and the lower limit value thereof is set as L_{B}. Examples of the oscillation status include a frequency upper limit value (L_{A}>S×I), an amplitude upper limit value and lower limit value (L_{A}>F×K>L_{B}), an oscillation maximum speed upper limit value (L_{A}>F×S+(F×K)×(2π×S×I)/2), an oscillation maximum acceleration upper limit value (L_{A}>(F×K)×(2π×S×I)²/2), an oscillation maximum jerk upper limit value (L_{A}>(F×K)×(2π×S×I)³/2), and the like. As another oscillation status, it is also possible to use a return speed upper limit value or the like. In this way, it is possible to set the upper limit values and the lower limit values of the oscillation status for various parameters related to the oscillation conditions.

The determination unit 13 is a determination function of determining whether or not a combination of the numerical values of the second machining conditions exists on the basis of a first criterion and the second criterion set in advance on the premise of the numerical values of the first machining conditions.

The first criterion is a condition set for an operation that varies on the basis of the first machining conditions and the second machining conditions. The first criterion is a condition set in advance for an operation based on the first machining conditions and the second machining conditions.

In the first embodiment, it is set as the first criterion for the oscillation acceleration (oscillation parameter) of an oscillating operation based on the first machining conditions and the second machining conditions to fall below the upper limit value acquired by the upper limit value acquisition unit 12. When the maximum acceleration is described as an upper limit value Aₘₐₓ, it is possible to express the first criterion as in Expression (1).

$$\begin{matrix}[ Expression 1 ] & \\ {A}_{max} > ( K \times F ) \times {( 2 π \times S \times I )}^{2} / 2 & Expression 1\end{matrix}$$

The second criterion is a condition set for an operation having a result that changes depending on only the second machining conditions. In the first embodiment, it is set as the second criterion to allow for shredding chips. It is possible to express the second criterion as in Expression (2). Expression (2) also shows that conditions for defining whether or not it is possible to shred chips are only the oscillation frequency multiplying factor I and the oscillation amplitude multiplying factor K set as second machining conditions.

$$\begin{matrix}[ Expression 2 ] & \\ K > 1 / \vert sin ( π \times I ) \vert & Expression 2\end{matrix}$$

It is to be noted that Expression (2) described above has been described as a condition for achieving an oscillating operation which allows for shredding chips. This is a condition under which tool route paths overlap in the n-th rotation and the n+1-th rotation to cause air cutting. However, it is actually possible to shred chips by sufficiently shortening the distance of a cutting path in some cases even if no air cutting is caused. The condition for achieving an oscillating operation that allows for shredding chips may be thus determined by further providing a margin to Expression (2) described above or whether or not the condition that allows for shredding chips is obtained may be determined with reference to the machining conditions of I and K and table data of actual machining results indicating whether or not it was possible to actually shred chips at that time.

The determination unit 13 determines whether or not the numerical values of second machining conditions that satisfy the first criterion in addition to the second criterion exist on the premise of the numerical values of the first machining conditions and the range thereof set in advance.

A method for determining whether or not the numerical values of the second machining conditions exist is not limited in particular. A table for which the numerical values of the second machining conditions within the range within which the second criterion is satisfied or the numerical range thereof is set may be set in advance for the numerical values of the first machining conditions and the presence or absence may be determined by inputting the numerical values of the first machining conditions. In the first embodiment, data of a table that is settable for the oscillation frequency multiplying factor I and the oscillation amplitude multiplying factor K and allows for shredding chips may be stored in advance in the calculation device 1 and it may be examined for all the combinations whether or not all the combinations fall below the upper limit values. Alternatively, the presence or absence of the numerical values may be determined on the basis of a result of plotting to a graph indicating the relationship among the inputs of the first machining conditions, the second machining conditions, the first criterion, and the second criterion.

The output unit 14 is an output function of outputting a determination result of the determination unit 13. In the present embodiment, the output unit 14 outputs a determination result of the determination unit 13 to the display device 2.

In the display device 2, a display control unit 15 is implemented as a functional unit. The display control unit 15 is a display control function of displaying, on the display unit 20, various kinds of information about the calculation device 1 and information for an input result of an operator. The display control unit 15 executes display control of displaying an image based on a determination result output from the output unit 14 on the display unit 20.

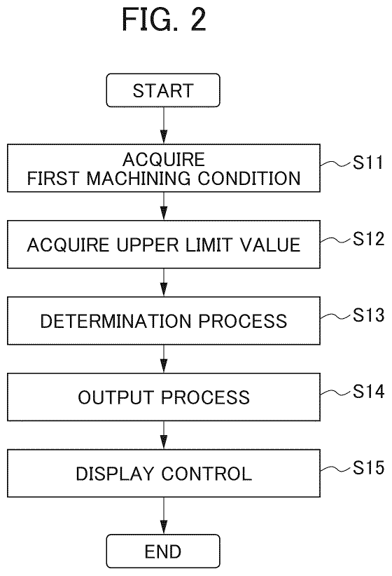

Next, the flow of a calculation control process will be described with reference to FIG. 2. FIG. 2 is a flowchart showing an example of the flow of the calculation control process by the calculation device 1 according to the first embodiment. The processing order or the processing contents shown in the flowchart are merely examples and the processing order or the processing contents are considered changeable as appropriate.

First, the machining condition acquisition unit 11 acquires a first machining condition among machining conditions on the basis of input information from an operator, setting information about the calculation device 1, and the like (Step S11). In addition, a machining condition that is not set as a first machining condition among the machining conditions serves as a second machining condition.

In this example, the machining conditions include a spindle rotation number S, a feed speed F, a frequency multiplying factor I, and an oscillation amplitude multiplying factor K. The spindle rotation number S=2000 and the feed speed F=0.10 then serve as first machining conditions the numerical values of which have already been input, and the frequency multiplying factor I and the oscillation amplitude multiplying factor K serve as second machining conditions that have to be determined subsequently. It is to be noted that the feed speed may be the feed amount per rotation of the spindle, the feed amount per time, or the feed amount per vibration.

Next, the upper limit value acquisition unit 12 acquires the upper limit value of an oscillation parameter set in advance (Step S12). In the first embodiment, the upper limit value acquisition unit 12 acquires an acceleration upper limit value.

Next, the determination unit 13 determines whether or not a combination of the numerical values of the second machining conditions that satisfy the first criterion and the second criterion exists (Step S13). For example, the determination unit 13 acquires the numerical range of a combination of the oscillation frequency multiplying factor I and the oscillation amplitude multiplying factor K that satisfy a condition (Expression (2)) for allowing for shredding chips. The determination unit 13 then determines whether or not the oscillation frequency multiplying factor I and the oscillation amplitude multiplying factor K that satisfy a condition (Expression (1)) for preventing the maximum acceleration from exceeding the upper limit value exist for the first machining conditions (the spindle rotation number S and the feed speed F) the numerical values of which have already been determined.

Next, the output unit 14 outputs a determination result of the determination unit 13 in Step S13 to the display control unit 15 of the display device 2 (Step S14). The display control unit 15 executes display control of displaying an image based on a determination result received from the output unit 14 on the display unit 20 (Step S15).

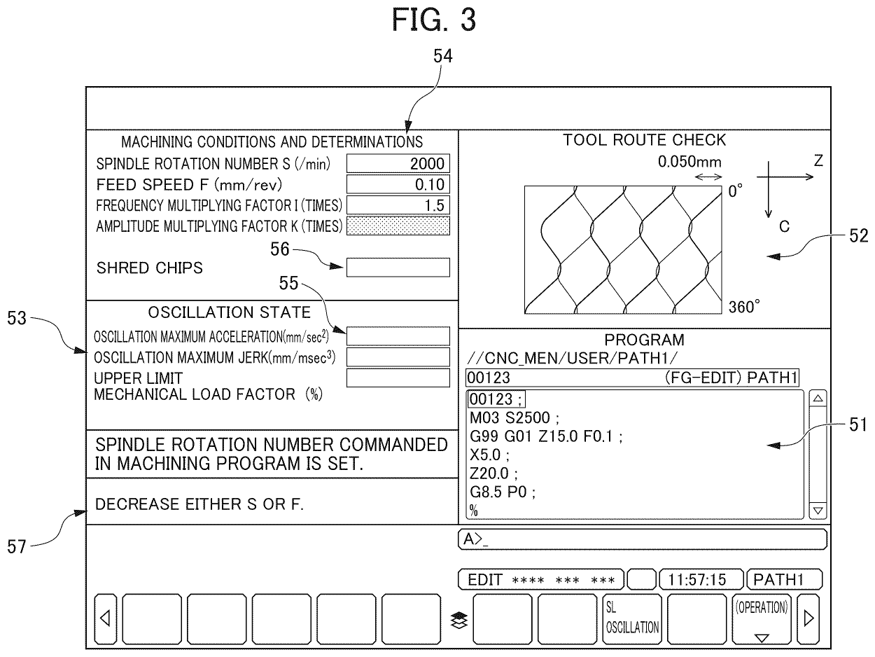

The determination result is presented to the operator through the series of processes above. Next, an example of an image displayed on the display unit 20 in a case where the determination unit 13 determines that an appropriate combination of the second machining conditions (the oscillation frequency multiplying factor I and the oscillation amplitude multiplying factor K) does not exist will be described with reference to FIG. 3. FIG. 3 is a diagram showing an example of an image displayed on the display unit 20 by the calculation device 1.

The image shown in FIG. 3 includes program display 51 indicating the contents of the machining program, tool route check display 52 indicating the machining route of the cutting tool, acceleration information display 53 in which information related to the maximum acceleration or the like is displayed, machining condition display 54 in which machining conditions are displayed, and text display 57.

In the acceleration information display 53, the maximum acceleration Aₘₐₓ and maximum jerk Jₘₐₓ calculated from the machining conditions are shown and an upper limit mechanical load factor (%) is shown.

The spindle rotation number S=4000 and the feed speed F=0.10 are input to the machining condition display 54 as first machining conditions. In addition, the oscillation frequency multiplying factor I and the oscillation amplitude multiplying factor K are blank as second machining conditions that have to be input subsequently. In addition, a field 56 indicates whether or not it is possible to shred chips. In this example, the field 56 indicates the second criterion.

In the text display 57, messages indicating a determination result of the determination unit 13 and having contents prompting changes of the first machining conditions are displayed. In this example, the appropriate oscillation frequency multiplying factor I and oscillation amplitude multiplying factor K that satisfy both the first criterion and the second criterion do not exist. The display control unit 15 therefore executes a display prompting a change which is also a message indicating that the appropriate oscillation frequency multiplying factor I and oscillation amplitude multiplying factor K do not exist. In this example, to present decreasing the spindle rotation number S and the feed speed F to the operator, “decrease either S or F” is displayed in the text display 57. Additionally, in a case where the articles of the oscillation frequency multiplying factor I and the oscillation amplitude multiplying factor K have not yet been input, the text described above may be displayed. It is to be noted that “decrease F” may also be displayed. In a case where S is decreased, cutting may be impossible because of the insufficient relative cutting speed of the workpiece and the tool. It is thus possible to decrease the possibility of machining failure by decreasing the feed speed F.

As described above, the calculation device 1 for a machine tool that performs oscillation machining while relatively oscillating the cutting tool according to the first embodiment and a workpiece attains the following effects.

The calculation device 1 according to the present embodiment includes the machining condition acquisition unit 11, the determination unit 13, and the output unit 14. The machining condition acquisition unit 11 acquires, as a first machining condition, at least one selected from a spindle rotation number, a feed speed, a frequency parameter, or an amplitude parameter included in machining conditions. The determination unit 13 acquires a first criterion and a second criterion as determination criteria. The first criterion is set for an oscillating operation based on the first machining condition and a second machining condition that is not acquired from the machining conditions as the first machining condition. The second criterion is set for an oscillating operation that is defined by only the second machining condition. The output unit 14 outputs a determination result of the determination unit 13. In a case where the numerical value of the first machining condition is applied, the determination unit 13 determines whether or not the numerical value of the second machining condition that satisfies the first criterion and the second criterion exists.

To allow an operator to grasp, in a machining phase, whether or not an oscillating operation based on a machining condition to be set satisfies a plurality of viewpoints (criteria), it has been conventionally necessary to make a simulation and a calculation, which are highly troublesome. In this regard, a configuration according to the present embodiment makes it possible to easily grasp, even in a machining condition setting phase, whether or not a machining condition to be set satisfies a plurality of viewpoints such as the first criterion and the second criterion.

In addition, in the present embodiment, the calculation device 1 further includes the upper limit value acquisition unit 12 acquires the upper limit value of an oscillation parameter set for oscillation machining. The machining condition acquisition unit 11 acquires the spindle rotation number and the feed speed as the first machining conditions. The first criterion is for the oscillation parameter to reach a value set with reference to the upper limit value (fall below the upper limit value). The second criterion is to allow for shredding chips. In a case where the respective numerical values of the spindle rotation number and the feed speed are applied, the determination unit 13 determines whether or not a numerical value that satisfies the first criterion exists in a combination of the setting values of the second machining conditions including the frequency parameter and the amplitude parameter that satisfy the second criterion. Whether or not generally allowable oscillation machining is executed is defined on the basis of the four of the spindle rotation number, the feed speed, the frequency multiplying factor, and the amplitude multiplying factor. Meanwhile, whether or not it is possible to shred chips is defined on the basis of the two of the frequency multiplying factor and the amplitude multiplying factor. In a case where oscillation machining is applied in a case where non-oscillation machining is being performed, the spindle rotation number and the feed speed have already been determined. To adjust the oscillation machining, only the two of the frequency multiplying factor and the amplitude multiplying factor are adjusted in many cases. In this regard, the configuration according to the present embodiment makes it possible to easily grasp whether or not the numerical values of the frequency multiplying factor and the amplitude multiplying factor are within an adjustable range without performing any complicated calculation or process on the premise that the numerical values of the spindle rotation number and the feed speed that have already been determined.

In addition, in the present embodiment, the calculation device 1 further includes the display control unit 15 that displays, on the display unit 20, an image based on the output of a determination result of the output unit 14. This allows an operator to visually grasp the situation more easily using the display on the display unit 20 even in the machining condition setting phase.

In addition, in the present embodiment, the first machining conditions include the feed speed. In a case where the determination unit 13 determines that the numerical values of the second machining conditions which satisfy the first criterion and the second criterion do not exist, the display control unit 15 displays, on the display unit 20, a display prompting a change of the numerical value of the feed speed in the first machining conditions. This makes it possible to decrease the possibility of machining failure by decreasing the feed speed in particular because, in a case where the spindle speed is decreased, the relative cutting speed of the workpiece and the tool may be insufficient to make cutting impossible.

In addition, in the present embodiment, the first machining conditions include the spindle rotation number. In a case where the determination unit 13 determines that the numerical values of the second machining conditions which satisfy the first criterion and the second criterion do not exist, the display control unit 15 displays, on the display unit 20, a display prompting a change of the numerical value of the spindle rotation number in the first machining conditions. This allows an operator to instantly understand that it is necessary to change the numerical value of the spindle rotation number and grasp the machining conditions still more easily.

### Second Embodiment

Next, the second embodiment in which first machining conditions and second machining conditions different from those of the embodiment described above are set will be described. It is to be noted that the components of the calculation device 1 according to the second embodiment are similar to the components of the first embodiment.

In the second embodiment, only the feed speed F=0.10 (mm/rev) is set as a first machining condition the numerical value of which has already been determined. In addition, the oscillation frequency multiplying factor I and the oscillation amplitude multiplying factor K are set as second machining conditions the numerical values of which have to be determined subsequently. At this time, the numerical value of a machining condition other than F, I, and K may already be determined, but the machining condition other than F, I, and K is not a first machining condition and a second machining condition in the present embodiment. It is to be noted that the numerical values of the second machining conditions may already be determined. However, even if the values have been input, the input values are ignored and the present technology is applied on the basis of a combination of the setting values of the second machining conditions which satisfy the second criterion again.

In the second embodiment, it is set as a first criterion for an index related to the target surface roughness of an oscillating operation based on the first machining conditions and the second machining conditions to fall below a desired value (upper limit value). For example, a setting range is calculated such that parameters of a publicly known function f (F, I, K) for calculating the target surface roughness such as the feed speed F, the oscillation frequency multiplying factor I, and the oscillation amplitude multiplying factor K satisfy a surface roughness upper limit value Rₘₐₓ>f(F, I, K). For example, it is sufficient if a nose R [mm] is separately acquired, the surface roughness at the time of oscillation cutting is calculated by numerical calculation on the basis of the cutting path calculated on the basis of F, I, and K and the nose R, and the setting range of the publicly known function f (F, I, K) is calculated such that this surface roughness at the time of oscillation cutting satisfies the surface roughness upper limit value Rₘₐₓ.

A second criterion according to the second embodiment is to achieve an oscillating operation (see Expression (2)) similar to that of the first embodiment which allows for shredding chips.

The determination unit 13 acquires a combination of the oscillation frequency multiplying factor I and the oscillation amplitude multiplying factor K (the numerical values or the numerical range) that satisfy the second criterion. In a case where F=0.10 of the first machining condition the numerical value of which has already been determined is applied, the determination unit 13 then determines whether or not the combinations of the oscillation frequency multiplying factor I and the oscillation amplitude multiplying factor K that satisfy the second criterion have numerical values that satisfy the first criterion. Display control over a determination result is similar to that of the embodiment described above.

### Third Embodiment

Next, a third embodiment in which first machining conditions and second machining conditions different from those of the embodiments described above are set will be described. It is to be noted that the components of the calculation device 1 according to the third embodiment are also similar to the components of the first embodiment.

In the third embodiment, only the feed speed F=0.10 (mm/rev) and the oscillation amplitude multiplying factor K=1.2 are set as first machining conditions the numerical values of which have already been determined. In addition, the spindle rotation number S and the oscillation frequency multiplying factor I are set as second machining conditions the numerical values of which have to be determined subsequently. It is to be noted that the numerical values of the second machining conditions may already be determined. However, even if the values have been input, the input values are ignored and the present technology is applied on the basis of a combination of the setting values of the second machining conditions which satisfy a second criterion again.

In the third embodiment, it is set as a first criterion for the feed speed of an oscillating operation based on the first machining conditions and the second machining conditions to fall below a desired value (upper limit value). For example, when the speed upper limit value is represented as Vmax, satisfying the condition shown in Expression (3) means satisfying the first criterion.

$$\begin{matrix}[ Expression 3 ] & \\ {V}_{max} > F \times S + ( F \times K ) \times ( 2 π \times S \times I ) / 2 & Expression 3\end{matrix}$$

The second criterion according to the third embodiment is to achieve an oscillating operation in which the frequency of the oscillating operation does not exceed an oscillation frequency upper limit value set in advance. For example, when the oscillation frequency upper limit value is represented as Frqₘₐₓ, satisfying the condition shown in Expression (4) means satisfying the second criterion.

$$\begin{matrix}[ Expression 4 ] & \\ F r {q}_{max} > S \times I & Expression 4\end{matrix}$$

The determination unit 13 acquires a combination of the spindle rotation number S and the oscillation frequency multiplying factor I (the numerical values or the numerical range) that satisfy the second criterion. In a case where F=0.10 and the oscillation amplitude multiplying factor K=1.2 of the first machining conditions the numerical values of which have already been determined are applied, the determination unit 13 then determines whether or not the combinations of the spindle rotation number S and the oscillation frequency multiplying factor I that satisfy the second criterion have numerical values that satisfy the first criterion. Display control over a determination result is similar to those of the embodiments described above.

### Fourth Embodiment

Next, a fourth embodiment in which first machining conditions and second machining conditions different from those of the embodiments described above are set will be described. It is to be noted that the components of the calculation device 1 according to the fourth embodiment are similar to the components of the first embodiment.

In the fourth embodiment, the oscillation frequency multiplying factor I=0.8 (times) is set as a first machining condition the numerical value of which has already been determined. In addition, the oscillation amplitude multiplying factor K is set as a second machining condition the numerical value of which has to be determined subsequently. At this time, the numerical value of a machining condition other than I and K may already be determined, but the machining condition other than I and K is not a first machining condition and a second machining condition in the present embodiment. It is to be noted that the numerical values of the second machining conditions may already be determined. However, even if the values have been input, the input values are ignored and the present technology is applied on the basis of a combination of the setting values of the second machining conditions which satisfy a second criterion again.

In the fourth embodiment, it is set as a first criterion for the oscillation amplitude of an oscillating operation based on the first machining condition and the second machining condition to fall below an amplitude multiplying factor upper limit value. That is, when the amplitude multiplying factor upper limit value is represented as Kₘₐₓ, satisfying Kₘₐₓ>K (oscillation amplitude multiplying factor to be set) means satisfying the first criterion.

The second criterion according to the fourth embodiment is to achieve an oscillating operation (see Expression (2)) similar to that of the first embodiment which allows for shredding chips.

The determination unit 13 acquires the oscillation amplitude multiplying factor K (the numerical value or the numerical range) that satisfies the second criterion. In a case where the oscillation frequency multiplying factor I=0.8 of the first machining condition the numerical value of which has already been determined is applied, the determination unit 13 then determines whether or not a numerical value that satisfies the first criterion exists within the range of the oscillation amplitude multiplying factor K that satisfies the second criterion. Display control over a determination result is similar to those of the embodiments described above.

### Fifth Embodiment

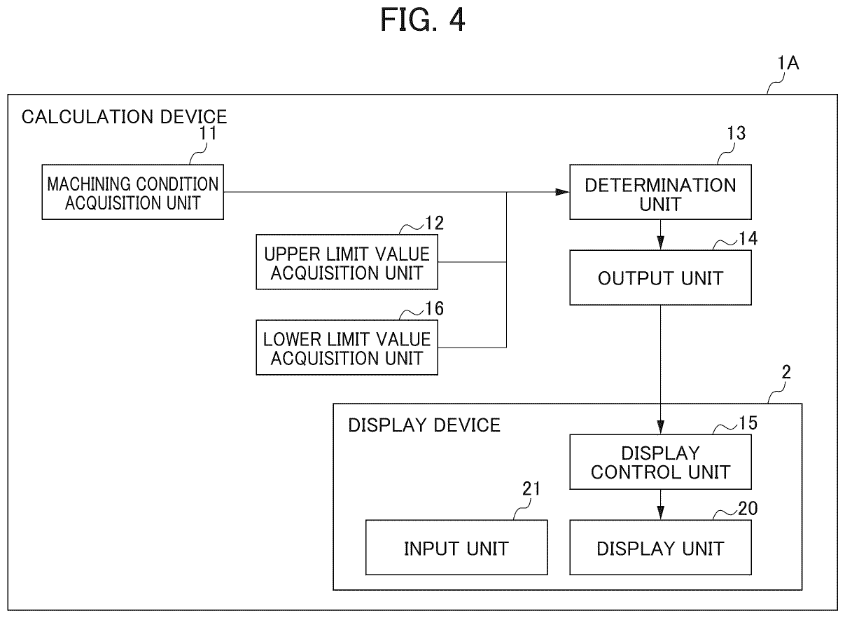

Next, a fifth embodiment in which components different from the components of the embodiments described above are included will be described. FIG. 4 is a functional block diagram of a calculation device 1A for a machine tool according to the fifth embodiment.

As shown in FIG. 4, the calculation device 1A according to the fifth embodiment includes the machining condition acquisition unit 11, the upper limit value acquisition unit 12, the determination unit 13, the output unit 14, and a lower limit value acquisition unit 16 as functional units. The configuration of the calculation device 1A according to the fifth embodiment is different in that the lower limit value acquisition unit 16 is further included in addition to the components of the first embodiment. It is to be noted that first machining conditions, second machining conditions, a first criterion, and a second criterion according to the fifth embodiment are similar to those of the first embodiment.

The lower limit value acquisition unit 16 acquires the lower limit value of the spindle rotation number based on input information from an operator, setting information about the calculation device 1A, and the like.

The determination unit 13 determines whether or not a combination of the numerical values of the second machining conditions that satisfy the first criterion and the second criterion exists. For example, the determination unit 13 acquires the numerical range of a combination of the oscillation frequency multiplying factor I and the oscillation amplitude multiplying factor K that satisfy a condition (Expression (2)) for allowing for shredding chips. The determination unit 13 then determines whether or not the oscillation frequency multiplying factor I and the oscillation amplitude multiplying factor K that satisfy a condition (Expression (1)) that the maximum acceleration falls below the upper limit value exist for the feed speed F in the first machining conditions the numerical values of which have already been determined and the lower limit value of the spindle rotation number acquired by the lower limit value acquisition unit 16. Display control over a determination result is similar to those of the embodiments described above.

As described above, the calculation device 1A according to the fifth embodiment further includes the lower limit value acquisition unit 16 that acquires the lower limit value of the spindle rotation number in addition to the components of the calculation device 1 described above. In a case where the respective numerical values of the lower limit value of the spindle rotation number and the feed speed are applied, the determination unit 13 determines whether or not the numerical value that satisfies the first criterion exists in the combination of the setting values of the second machining conditions including the frequency parameter and the amplitude parameter that satisfy the second criterion. This makes it possible to grasp whether or not a set machining condition satisfies both the first criterion and the second criterion set using the numerical value of the spindle rotation number at the lower limit value as a determination base.

### Sixth Embodiment

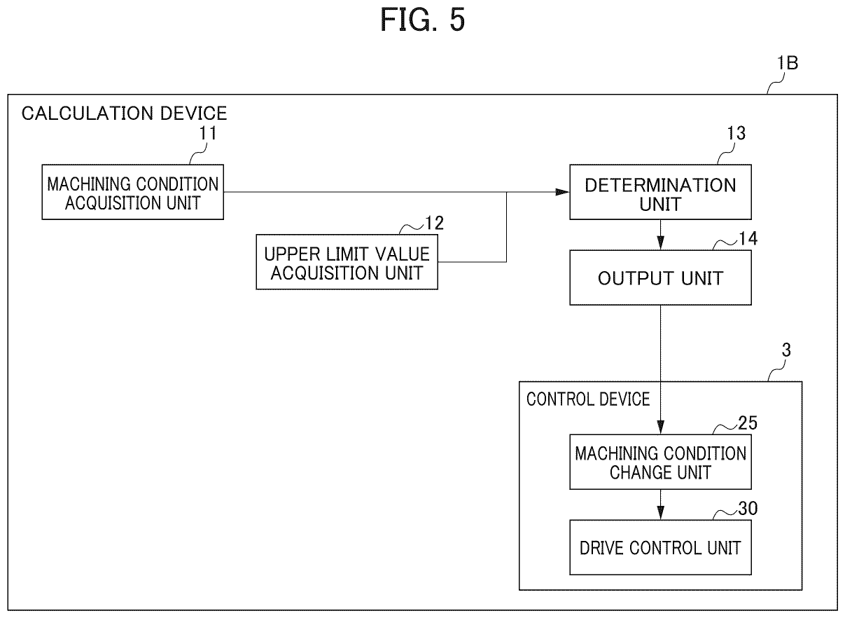

Next, an example of a calculation device 1B including a control device 3 will be described. FIG. 5 is a functional block diagram of the calculation device 1B for a machine tool according to a sixth embodiment. It is to be noted that the calculation device 1B is not configured to include a display device in FIG. 5, but may further include the display device 2 as described in the first embodiment.

As shown in FIG. 5, the calculation device 1B includes the machining condition acquisition unit 11, the upper limit value acquisition unit 12, the determination unit 13, and the output unit 14 as functional units as in the first embodiment. In addition, the calculation device 1B may be configured to include a CNC as in the first embodiment.

In addition, the calculation device 1B includes the control device 3 that executes machining control over a machine tool. The control device 3 includes a computer common or similar to the calculation device 1B. In the control device 3, a machining condition change unit 25 and a drive control unit 30 are implemented as functional units that are brought into operation by the CPU.

The machining condition change unit 25 is a machining condition change function of changing a machining condition depending on a determination result of the determination unit 13 output from the output unit 14. For example, in a case where the determination unit 13 determines that a combination of the second machining conditions (the oscillation frequency multiplying factor I and the oscillation amplitude multiplying factor K) does not exist, the numerical value of the first machining condition of the spindle rotation number or the feed speed or the numerical values of the first machining conditions of both of them are changed. For example, a change from the spindle rotation number S=4000 to the spindle rotation number S=2000 is made. This assumes a case where the spindle rotation number S described above is changed when it is determined that a combination of the frequency multiplying factor I and the amplitude multiplying factor K does not exist in a case where a condition acquired by the machining condition acquisition unit 11 is “making a setting (any setting means is acceptable) for an automatic setting to the frequency multiplying factor I and the amplitude multiplying factor K that allow for shredding chips”.

The drive control unit 30 is an axis control function of controlling, when receiving information indicating the machining condition changed by the machining condition change unit 25, an operation axis on the basis of the contents of the machining condition.

As described above, the calculation device 1B according to the sixth embodiment further includes the machining condition change unit 25 that changes a machining condition on the basis of the output of the determination result from the output unit 14 and the drive control unit 30 that performs axis control on the basis of the changed machining condition in addition to the components of the calculation device 1 described above. This automatically adjusts the numerical value of the machining condition and executes an appropriate oscillating operation even in a case where the numerical value is within the range within which it is not possible to perform an appropriate oscillating operation or it is not possible to shred chips.

As described above, various combinations are applicable to the first machining conditions and the second machining conditions.

It is to be noted that the present disclosure is not limited to the embodiments and Modification Example described above. The present disclosure includes modifications and improvements within the range that allows the object of the present disclosure to be achieved.

As to the embodiments and Modification Example described above, the following supplements will be further disclosed.

### (Additional Remark 1)

A calculation device (1, 1A, 1B) for a machine tool that performs oscillation machining while relatively oscillating a cutting tool and a workpiece, the calculation device (1, 1A, 1B) including:
a machining condition acquisition unit (11) configured to acquire, as a first machining condition, at least one selected from a spindle rotation number, a feed speed, a frequency parameter, or an amplitude parameter included in machining conditions;
a determination unit (13) configured to acquire a first criterion and a second criterion as determination criteria, the first criterion being set for an oscillating operation that is based on the first machining condition and at least one second machining condition that is not acquired from the machining conditions as the first machining condition, the second criterion being set for an oscillating operation that is defined by only the second machining condition; and
an output unit (14) configured to output a determination result of the determination unit (13). In a case where a numerical value of the first machining condition is applied, the determination unit (13) determines whether or not a numerical value of the second machining condition that satisfies the first criterion and the second criterion exists.

### (Additional Remark 2)

The calculation device (1, 1A, 1B) further including
an upper limit value acquisition unit (12) configured to acquire an upper limit value of an oscillation parameter set for the oscillation machining,
the machining condition acquisition unit (11) acquires the spindle rotation number and the feed speed as the first machining condition,
the first criterion is for the oscillation parameter to reach a value set with reference to the upper limit value,
the second criterion is to allow for shredding a chip, and in a case where respective numerical values of the spindle rotation number and the feed speed are applied, the determination unit (13) determines whether or not a numerical value that satisfies the first criterion exists in a combination of setting values of the second machining condition including the frequency parameter and the amplitude parameter that satisfy the second criterion.

### (Additional Remark 3)

The calculation device (1, 1A, 1B), further including a display control unit (15) configured to display an image on a display unit (20), the image being based on an output of a determination result from the output unit (14).

### (Additional Remark 4)

The calculation device (1, 1A, 1B), in which the first machining condition includes the feed speed, and in a case where the determination unit (13) determines that the numerical value of the second machining condition which satisfies the first criterion and the second criterion does not exist, the display control unit (15) displays, on the display unit (20), a display prompting a change of a numerical value of the feed speed in the first machining condition.

### (Additional Remark 5)

The calculation device (1, 1A, 1B),
the first machining condition includes the spindle rotation number, and
in a case where the determination unit (13) determines that the numerical value of the second machining condition which satisfies the first criterion and the second criterion does not exist, the display control unit (15) displays, on the display unit (20), a display prompting a change of a numerical value of the spindle rotation number in the first machining condition.

### (Additional Remark 6)

The calculation device (1A), further including a lower limit value acquisition unit (16) configured to acquire a lower limit value of the spindle rotation number, and
in a case where the respective numerical values of the lower limit value of the spindle rotation number and the feed speed are applied, the determination unit (13) determines whether or not the numerical value that satisfies the first criterion exists in the combination of the setting values of the second machining condition including the frequency parameter and the amplitude parameter that satisfy the second criterion.

### (Additional Remark 7)

The calculation device (1B), further including:
a machining condition change unit (25) configured to change the machining conditions on the basis of an output of a determination result from the output unit (14); and
a drive control unit (30) configured to perform axis control on the basis of the changed machining conditions.

### EXPLANATION OF REFERENCE NUMERALS

1, 1A, 1B: calculation device
2: display device
3: control device
11: machining condition acquisition unit
12: upper limit value acquisition unit
13: determination unit
14: output unit
15: display control unit
16: lower limit value acquisition unit
20: display unit
21: input unit
25: machining condition change unit
30: drive control unit

1. A calculation device for a machine tool that performs oscillation machining while relatively oscillating a cutting tool and a workpiece, the calculation device comprising:
a machining condition acquisition unit configured to acquire, as a first machining condition, at least one selected from a spindle rotation number, a feed speed, a frequency parameter, or an amplitude parameter included in machining conditions;
a determination unit configured to acquire a first criterion and a second criterion as determination criteria, the first criterion being set for an oscillating operation that is based on the first machining condition and at least one second machining condition that is not acquired from the machining conditions as the first machining condition, the second criterion being set for an oscillating operation that is defined by only the second machining condition; and
an output unit configured to output a determination result of the determination unit, wherein
in a case where a numerical value of the first machining condition is applied, the determination unit determines whether or not a numerical value of the second machining condition that satisfies the first criterion and the second criterion exists.

2. The calculation device according to claim 1, further comprising:
an upper limit value acquisition unit configured to acquire an upper limit value of an oscillation parameter set for the oscillation machining, wherein
the machining condition acquisition unit acquires the spindle rotation number and the feed speed as the first machining condition,
the first criterion is for the oscillation parameter to reach a value set with reference to the upper limit value,
the second criterion is to allow for shredding a chips, and
in a case where respective numerical values of the spindle rotation number and the feed speed are applied, the determination unit determines whether or not a numerical value that satisfies the first criterion exists in a combination of setting values of the second machining condition including the frequency parameter and the amplitude parameter that satisfy the second criterion.

3. The calculation device according to claim 1, further comprising:
a display control unit configured to display an image on a display unit, the image being based on an output of a determination result from the output unit.

4. The calculation device according to claim 3, wherein
the first machining condition includes the feed speed, and
in a case where the determination unit determines that the numerical value of the second machining condition which satisfies the first criterion and the second criterion does not exist, the display control unit displays, on the display unit, a display prompting a change of a numerical value of the feed speed in the first machining condition.

5. The calculation device according to claim 3, wherein
the first machining condition includes the spindle rotation number, and
in a case where the determination unit determines that the numerical value of the second machining condition which satisfies the first criterion and the second criterion does not exist, the display control unit displays, on the display unit, a display prompting a change of a numerical value of the spindle rotation number in the first machining condition.

6. The calculation device according to claim 2, further comprising:
a lower limit value acquisition unit configured to acquire a lower limit value of the spindle rotation number, wherein
in a case where the respective numerical values of the lower limit value of the spindle rotation number and the feed speed are applied, the determination unit determines whether or not the numerical value that satisfies the first criterion exists in the combination of the setting values of the second machining condition including the frequency parameter and the amplitude parameter that satisfy the second criterion.

7. The calculation device according to claim 1, further comprising:
a machining condition change unit configured to change the machining conditions on a basis of an output of a determination result from the output unit; and
a drive control unit configured to perform axis control on a basis of the changed machining conditions.
